(19) United States
(12) Patent Application Publication
(10) Pub. No.: US 2009/0245393 A1
(43) Pub. Date: Oct. 1, 2009

(54) Method and Apparatus For Fast Channel Change For Digital Video

(76) Inventors: Alan Jay Stein, Princeton Junction, NJ (US); Jiwang Dai, Princeton Junction, NJ (US); John Qiang Li, BelleMead, NJ (US); Xiuping Lu, Hillsborough, NJ (US)

Correspondence Address: Thomson Licensing LLC, P.O. Box 5312, Two Independence Way, PRINCETON, NJ, 08543-5312, US

(21) Appl. No.: 12/309,571

(22) PCT Filed: Jul. 25, 2007
(86) PCT No.: PCT/US2007/016788

§ 371 Date: Jan. 23, 2009

Related U.S. Application Data
(60) Provisional application No. 60/834,308, filed on Jul. 28, 2006.

(51) Int. Cl. H04N 11/02

(52) U.S. Cl. 375/240.28; 375/E07.01

(57) ABSTRACT

There are provided methods and apparatus for fast channel change for digital video. An apparatus includes at least one encoder for receiving normal video data and channel change video data and encoding the normal video data and the channel change video data in a normal video stream and a channel change video stream, respectively, using a common system clock to provide synchronization between the normal video stream and the channel change video stream. The normal video stream and the channel change video stream are encoded for transport separately at a transport level.

### CROSS-REFERENCE TO RELATED APPLICATIONS

This application claims the benefit of U.S. Provisional Application Ser. No. 60/834,308, filed 28 Jul. 2006, which is incorporated by reference herein in its entirety.

### GOVERNMENT LICENSE RIGHTS IN FEDERALLY SPONSORED RESEARCH AND DEVELOPMENT

The U.S. Government has a paid-up license in this invention and the right in limited circumstances to require the patent owner to license others on reasonable terms as provided for by the terms of project ID contract No. 2003005676B awarded by the National Institute of Standards and Technology.

### TECHNICAL FIELD

The present principles relate generally to digital video and, more particularly, to methods and apparatus for fast channel change for digital video.

### BACKGROUND

Modern video compression techniques can achieve a very high degree of compression by utilizing the temporal correlation of video frames. In a group of pictures (GOP), only one picture is entirely intra coded and the remaining pictures are encoded wholly or partially based on redundancy shared with other pictures. An intra coded picture (I) uses only redundancy within itself to produce compression. Inter-coded pictures (B or P pictures), however, must be decoded after the related intra coded picture(s) is/are decoded. Since I pictures typically require 3 to 10 times more bits than a B or P picture, they are encoded much less frequently in the bit stream in order to reduce the overall bit rate. In general, for the same video sequence, a stream encoded with a relatively large number of pictures included within a GOP (e.g. >2 seconds worth of video) has a significantly lower bit rate than the one encoded with a short (e.g., <=1 second worth of video) GOP size.

However, using a GOP size which is relatively large has an unintentionally adverse effect on the channel change latency. When a receiver tunes to a program, the receiver must wait until the first I picture is received before any picture can be decoded or displayed. Less frequent I pictures can cause longer delays in a channel change.

Most broadcast systems transmit I pictures frequently, for example, every 1 second or so, in order to limit the channel change delay time due to the video compression system. However, more frequent I pictures significantly increase the overall bit-rate.

Other systems use devices in the transport network to buffer a latest portion of the broadcast stream. When the user requests a channel change from his/her set top box (STB), the network device unicasts the buffered video starting from an I picture to the set top box. The unicast stream is either transferred at a faster than normal bitrate or transferred at a normal bitrate. The set top box will switch to the corresponding broadcast stream after an I picture of this stream is received.

A deficiency of such systems is that they require complex middleware support. Such systems also require the hardware be deployed in the transport network to store and unicast streams. The bandwidth and storage requirement for such systems has to scale with the number of concurrent users.

Another proposed rapid channel change approach is for an Internet Protocol (IP) based system in which a channel change stream is encoded and transmitted along with the normal video bitstream through a separate Internet Protocol multicast stream. The channel change stream includes lower quality I pictures that are sent at a higher frequency than I pictures in the normal bitstream. During channel change, the STB sends a join command for each of the two streams. Upon receiving the commands, the Digital Subscriber Line Access Mutliplexer (DSLAM) forwards both streams to the set top box. The set top box then decodes and displays the channel change stream until an I picture of the regular stream is received. The set top box then sends an Internet Group Management Protocol (IGMP) leave command to request the Digital Subscriber Line Access Mutliplexer to stop forwarding the channel change stream.

However, the majority of digital broadcast television (TV) systems are MPEG transport stream (TS) based. Examples include, but are not limited to, digital television broadcast over Hybrid Fiber Coax (HFC) cable and DirectTV satellite television distribution. Even in most commercial Internet Protocol television systems, television programs are first multiplexed into an MPEG-2 transport stream before being packetized to Internet Protocol packets. Most application layer operations, such as program multiplexing and de-multiplexing, audio/video synchronization, clock synchronization and conditional access are handled at the MPEG-2 TS layer. The Internet Protocol encapsulation is only used for transportation layer services.

### SUMMARY

These and other drawbacks and disadvantages of the prior art are addressed by the present principles, which are directed to methods and apparatus for fast channel change for digital video.

According to an aspect of the present principles, there is provided an apparatus. The apparatus includes at least one encoder for receiving normal video data and channel change video data and encoding the normal video data and the channel change video data in a normal video stream and a channel change video stream, respectively, using a common system clock to provide synchronization between the normal video stream and the channel change video stream. The normal video stream and the channel change video stream are encoded for transport separately at a transport level.

According to another aspect of the present principles, there is provided a method. The method includes receiving normal video data and channel change video data, and encoding the normal video data and the channel change video data in a normal video stream and a channel change video stream, respectively, using a common system clock to provide synchronization between the normal video stream and the channel change video stream. The normal video stream and the channel change video stream are encoded for transport separately at a transport level.

According to yet another aspect of the present principles, there is provided an apparatus. The apparatus includes at least one decoder and a phase adjuster. The at least one decoder is for receiving normal video data and channel change video data separately at a transport layer and decoding the normal video data and the channel change video data from a normal video stream and a channel change video stream, respectively. The phase adjuster is for phase adjusting at least one of the normal video stream and the channel change video stream to provide synchronization between the normal video stream and the channel change video stream.

According to a further aspect of the present principles, there is provided a method. The method includes receiving normal video data and channel change video data separately at a transport layer and decoding the normal video data and the channel change video data from a normal video stream and a channel change video stream, respectively. The method further includes phase adjusting at least one of the normal video stream and the channel change video stream to provide synchronization between the normal video stream and the channel change video stream.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows a block diagram for an exemplary set top box (STB) to which the present principles may be applied, in accordance with an embodiment of the present principles;

FIG. 2 shows a block diagram for another exemplary set top box (STB) to which the present principles may be applied, in accordance with an embodiment of the present principles;

FIG. 3 shows a diagram for an exemplary channel change Group Of Pictures (GOP) structure, in accordance with an embodiment of the present principles;

FIG. 4 shows a block diagram for an exemplary clock synchronization system for synchronization clock values between two Transport Streams that respectively carry the regular and the channel change video stream, in accordance with an embodiment of the present principles;

FIG. 5 shows the phase adjuster 130 of FIG. 4 in further detail, in accordance with an embodiment of the present principles;

FIG. 6 shows a flow diagram for an exemplary method for performing a fast channel change for digital video, in accordance with an embodiment of the present principles;

FIG. 7 shows a flow diagram for another exemplary method for performing a fast channel change for digital video, in accordance with an embodiment of the present principles;

FIG. 8 shows a block diagram for an exemplary end-to-end architecture in accordance with the principles of the present invention;

FIG. 9 shows a flow diagram for an exemplary method for encoding digital media to allow a subsequent fast channel change, in accordance with an embodiment of the present principles; and

FIG. 10 shows a flow diagram for an exemplary method for encoding digital media to allow a subsequent fast channel change, in accordance with an embodiment of the present principles.

### DETAILED DESCRIPTION

The present principles are directed to methods and apparatus for fast channel change for digital video.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

It is to be appreciated that while one or more embodiments of the present principles are described herein with respect to a Digital Subscriber Line (DSL) system, the present principles are not limited solely to DSL systems and, thus, may be used with respect to any media transmission system that uses a transport stream including, but not limited to, MPEG-2 transport streams. Thus, for example, the present principles may be utilized with respect to cable television systems, satellite television systems, and so forth, while maintaining the spirit of the present principles.

Turning to FIG. 8, an exemplary end-to-end architecture to which the present principles may be applied in indicated generally by the reference numeral 800.

The architecture 800 includes a regular encoder 805 having an output (for providing a regular stream) connected in signal communication with a first input of a transport network 820, and a low bit-rate encoder 810 having an output (for providing a channel change stream) connected in signal communication with a second input of the transport network 820. An output (for providing a regular stream and a channel change stream) of the transport network 820 is connected in signal communication with an input of a set top box 830. An output (for providing video and audio) of the set top box 830 is connected in signal communication with an input of a television (TV) 840. An input of the regular encoder 805 and an input of the low bit rate encoder 810 are available as inputs of the architecture 800, for receiving video and audio. The transport network 820 includes a multiplexer 821. While shown in the transport network 820, it is to be appreciated that the multiplexer 821 may be disposed at another location including, but not limited to, before the transport network 820. Moreover, in another embodiment, a single scalable encoder may be used to generate the multiple streams, with a multiplexer integrated therein. These and other configurations of the elements of FIG. 8 are readily contemplated by one of ordinary skill in this and related arts, while maintaining the spirit of the present principles.

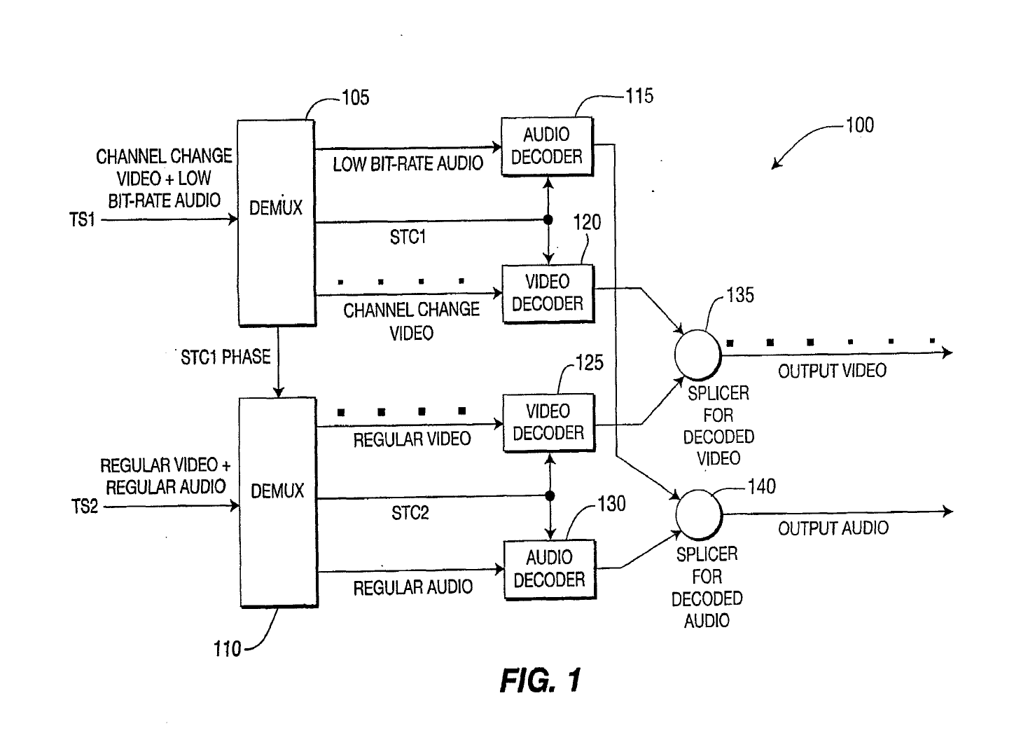

Turning to FIG. 1, an exemplary set top box (STB) to which the present principles may be applied is indicated generally by the reference numeral 100. The set top box 100 includes a demultiplexer (demux) 105 and a demultiplexer (demux) 110.

The demultiplexer 105 includes a first output (for providing low bit-rate audio) connected in signal communication with a first input of an audio decoder 115, a second output (for providing STC1, the system time clock recovered from the input stream of demultiplexer 105) in signal communication with a second input of the audio decoder 115 and a second input of a video decoder 120, a third output (for providing channel change video) in signal communication with a first input of the video decoder 120, and a fourth output (for providing STC1 phase) connected in signal communication with a second input of the demultiplexer 110.

The demultiplexer 110 includes a first output (for providing regular video) connected in signal communication with a first input of a video decoder 125, a second output (for providing STC2, the system time clock recovered from the input stream of demultiplexer 110) in signal communication with a second input of the video decoder 125 and a second input of an audio decoder 130, and a third output (for providing regular audio) in signal communication with a first input of the audio decoder 130.

An output of the video decoder 120 is connected in signal communication with a first input of a splicer for decoded video 135. An output of the video decoder 125 is connected in signal communication with a second input of the splicer for decoded video 135. An output of the audio decoder 115 is connected in signal communication with a first input of a splicer for decoded audio 140. An output of the audio decoder 130 is connected in signal communication with a second input of the splicer for decoded audio 140.

An input of the demultiplexer 105 is available as an input to the STB 100, for receiving channel change video and low bit-rate video in a first transport stream (TS1). A second input of the demultiplexer 110 is available as an input to the STB 100, for receiving regular video and regular audio in a second transport stream (TS2). An output of the splicer for decoded video 135 is available as an output of the STB 100, for outputting video. An output of the splicer for decoded audio 140 is available as an output of the STB 100, for outputting audio.

It is to be appreciated that the present principles are not limited solely to the elements and arrangements thereof shown in FIG. 1 and, thus, given the teachings of the present principles provided herein, one of ordinary skill in this and related arts will contemplate these and various other elements and arrangements thereof for implementing the present principles, while maintaining the spirit of the present principles. For example, a multiplexer may be used in place of any of the splicers 135 and 140.

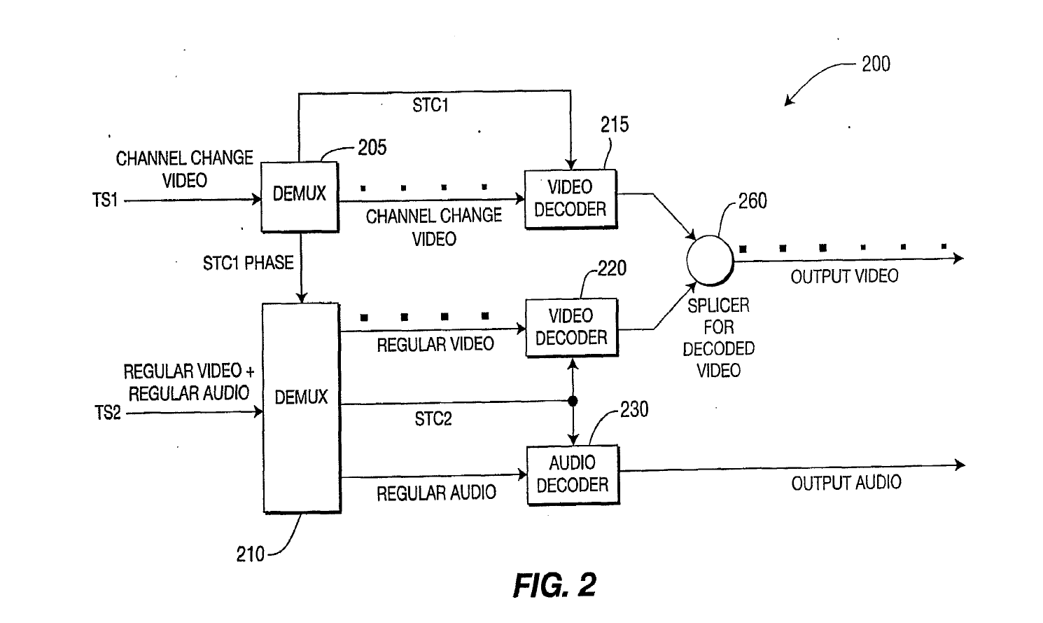

Turning to FIG. 2, another exemplary set top box (STB) to which the present principles may be applied is indicated generally by the reference numeral 200. The set top box 200 includes a demultiplexer (demux) 205 and a demultiplexer (demux) 210.

The demultiplexer 205 includes a first output (for providing channel change video) connected in signal communication with a first input of a video decoder 215, a second output (for providing STC1) connected in signal communication with a second input of the video decoder 215, and a third output (for providing STC1 phase) connected in signal communication with a demultiplexer 210.

The demultiplexer 210 includes a first output (for providing regular video) connected in signal communication with a first input of a video decoder 220, a second output (for providing STC2) connected in signal communication with a second input of the video decoder 220 and a second input of an audio decoder 230, and a third output (for providing regular audio) connected in signal communication with a first input of the audio decoder 230.

An output of the video decoder 215 is connected in signal communication with a first input of a splicer for decoded video 260. An output of the video decoder 220 is connected in signal communication with a second input of the splicer for decoded video 260.

An input of the demultiplexer 205 is available as an input of the set top box 200, for inputting channel change video in a first transport stream (TS1). A first input of the demultiplexer 210 is available as an input of the set top box 200, for inputting regular video and regular audio in a second transport stream (TS2). An output of the splicer for decoded video 260 is available as an output of the set top box 200, for outputting video data. An output of the audio decoder 230 is available as an output of the set top box 200, for outputting audio data.

It is to be appreciated that the present principles are not limited solely to the elements and arrangements thereof shown in FIG. 2 and, thus, given the teachings of the present principles provided herein, one of ordinary skill in this and related arts will contemplate these and various other elements and arrangements thereof for implementing the present principles, while maintaining the spirit of the present principles. For example, a multiplexer may be used in place of the splicer 260.

As noted above, the present invention is directed to methods and apparatus for fast channel change in digital video. Advantageously, the present principles provide a scalable solution for large scale Internet Protocol Television (IPTV) deployment. Moreover, the fast channel change stream provided in accordance with the present principles can be re-used for other applications such as Picture-In-Picture (PIP) and Mosaic view.

Therefore, in accordance with the principles of various embodiments of the present invention, channel change latency in a MPEG-2 transport stream (TS) based digital video broadcast system is significantly reduced.

In an embodiment, this is achieved by encoding a channel change stream (CCS) in addition to the normal coded stream, for each video program. The term normal stream here is not meant to imply any specific type or quality of encoding (e.g., the normal coded stream may be standard-definition, high-definition, or even less than standard-definition in quality). The channel change stream (CCS) differs from the normal coded stream in that the channel change stream has a lower bit-rate and typically lower resolution, but more frequent random access frames (I frames) than the normal stream. It is to be appreciated that the phrases “normal stream” and “regular stream”, and similar phrases, are used interchangeably herein.

In an embodiment, the channel change stream is simulcast along with the regular stream through either a separate or the same transport stream. The channel change stream may or may not carry an audio stream. During the channel change, the set top box (STB) decodes and displays the channel change stream until the first I frame of the regular stream is received. The set top box then uses the normal stream for decoding and displaying.

In an embodiment in which the channel change stream is transferred in a separate transport stream, after channel change is finished, the channel change stream reception may be terminated by the set top box. The channel change stream may also be used for mosaic or picture-in-picture (PIP) applications at the set top box.

In an embodiment of the present invention, for those cases where the normal stream and the channel change stream are transported in different transport streams at the transport layer, there is a need to ensure synchronization between the two streams. This may be accomplished, for example, by ensuring that at the encoder, both streams utilize the same program clock reference (PCR) clock. At the decoder, synchronization is accomplished via a phase adjuster.

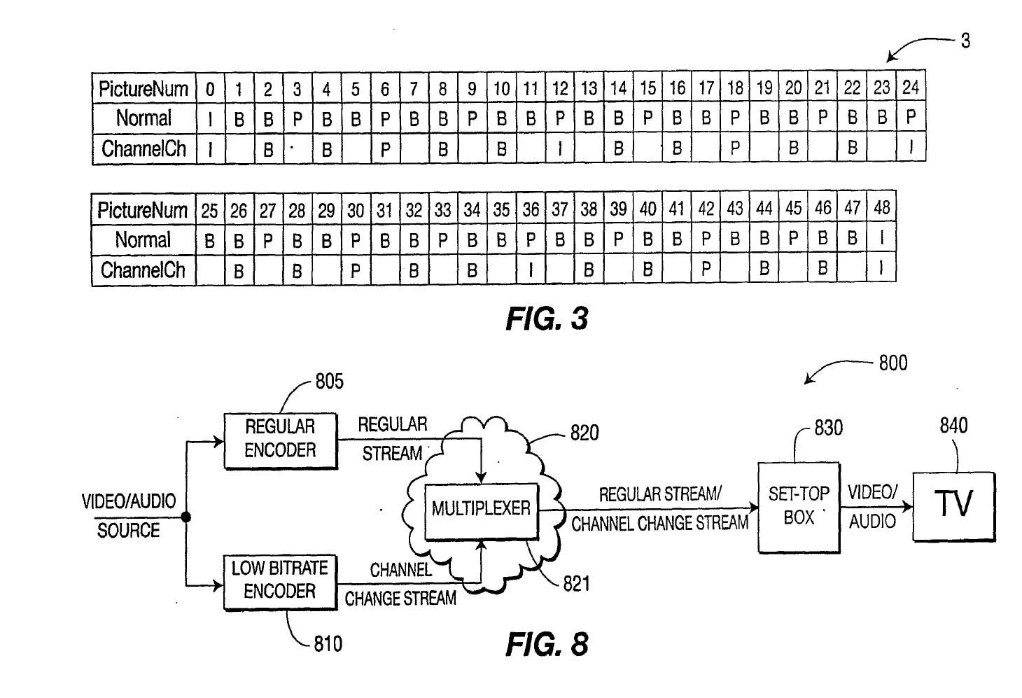

A channel change stream in encoded at a lower bitrate (for example, but not limited to the following percentage, 15% of the regular stream) to include lower quality, and possibly lower resolution coded pictures that are associated with normal quality pictures in the normal stream. It is to be appreciated that not all pictures present in the normal stream need to have an associated picture in the channel change stream. In an embodiment, I pictures occur more frequently in the channel change stream, to enable more frequent random access. Turning to FIG. 3, an exemplary channel change Group Of Pictures (GOP) structure is indicated generally by the reference numeral 300.

Regarding the delivery of the channel change stream, two exemplary embodiments are provided herein. Of course, it is to be appreciated that the present principles are not limited to solely these two embodiments regarding the delivery of the channel change stream and, given the teachings of the present principles provided herein, one of ordinary skill in this and related arts will contemplate these and various other options regarding the delivery of the channel change stream, while maintaining the spirit of the present principles.

In the first embodiment regarding the delivery of the channel change stream, the channel change video and associated audio streams are multiplexed into one Transport Stream, while the regular video and associated audio streams are multiplexed into another Transport Stream. The audio streams that are associated with the channel change video stream may have the same or a lower bit rate than the audio streams associated with the regular video stream. The decoder architecture of this embodiment is illustrated in FIG. 1.

In the second embodiment regarding the delivery of the channel change stream, the channel change video stream is delivered in one Transport Stream without audio streams. The regular video stream and associated audio streams are multiplexed into a separate Transport Stream. The decoder architecture of this embodiment is illustrated in FIG. 2.

The channel change video stream and the regular video stream are time synchronized in each of these embodiments. In the first and second embodiment, the time synchronization between the channel change and regular stream is maintained by using the same system clock and presentation timestamps in each packet elementary stream (PES).

PTS (presentation time stamp)—In an exemplary embodiment, it is a 33-bit value in the PES header that indicates the time of presentation in the system target decoder of a presentation unit of an elementary stream. In an embodiment, the value of the PTS is specified in units of the period of the system clock frequency divided by 300 (yielding 90 kHZ).

PCR (program clock reference)—In an exemplary embodiment, it is a 42-bit field whose value indicates the monolithic value of a 27 MHZ system clock. PCR is normally transferred as a separate program (with its PID) in the Transport Stream. PCR values are required every 40 ms to 100 ms depending on system specifications (e.g. Advanced Television Systems Committee (ATSC), Digital Video Broadcasting (DVB), and so forth).

For the first and second embodiments, there are two options in delivering the Transport Stream that carries the channel change video stream. In a non-switched network such as cable (e.g., HFC) or satellite broadcast, the channel change transport stream is delivered to the set top box at all times. In a switched network such as fiber or Digital Subscriber Line (DSL) based Internet Protocol Television (IPTV) network, the channel change transport stream is delivered to the multicast fork point such as a Digital Subscriber Line Access Mutliplexer (DSLAM) or a switch. During channel change, the set top box will send the appropriate multicast join command(s) to request for the channel change stream along with the regular stream. Normally, two (2) IGMP join commands are sent simultaneously by the set top box to join both the regular and low resolution stream. However, with appropriate middleware or Digital Subscriber Line Access Mutliplexer support, it's possible that only an IGMP join command is needed to join both streams. After the channel change is completed, the set top box will send the multicast leave command to stop the stream from being forwarded from the multicast fork point. This reduces the bandwidth usage between the multicast join point and the set top box.

For the first embodiment, an audio stream that is associated with the channel change video stream is first decoded and played. The decoder then switches to the audio stream that is associated with the regular video stream. For the second embodiment, during and after the channel change, an audio stream that is associated with the regular video stream is decoded and played.

For the first and second embodiments, since the transfer delay of the two streams may be different, their system clock after clock recovery may have a phase shift. A phase compensation unit may be employed with respect to at least one of the two streams to remove the phase difference of the two system clocks before they are fed into the decoder.

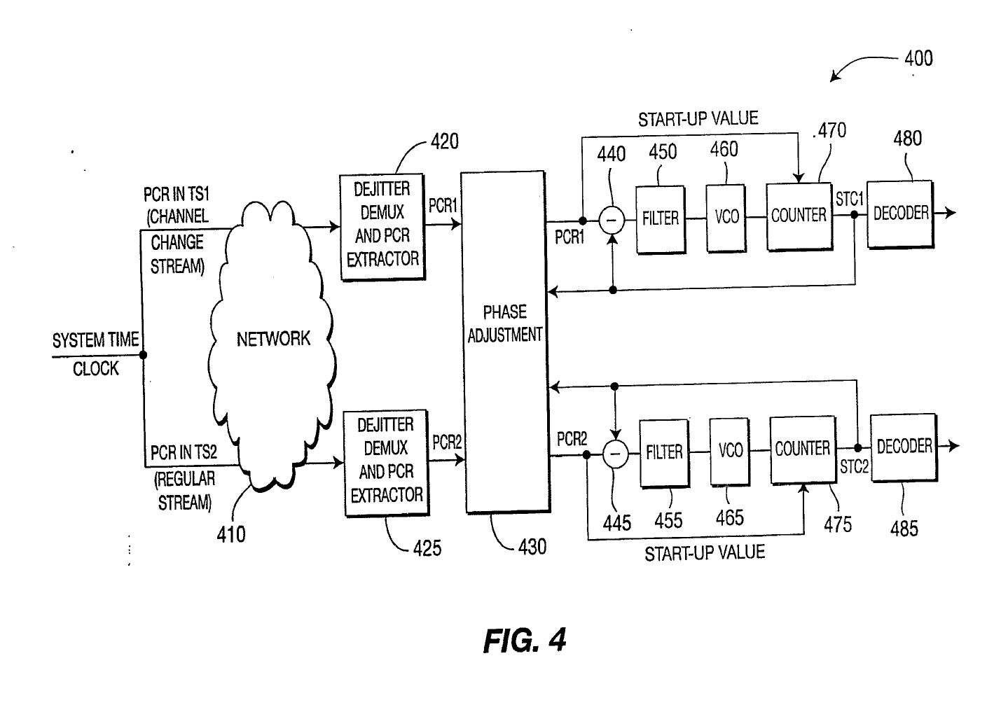

Turning to FIG. 4, an exemplary clock synchronization system for synchronization clock values between two Transport Streams that respectively carry the regular and the channel change video stream is indicated generally by the reference numeral 400. The clock synchronization system 400 includes a network 410 having a first output connected in signal communication to a dejitter demultiplexer and PCR extractor 420, and a second output connected in signal communication with a dejitter demultiplexer and PCR extractor 425. An output (for providing PCR1) of the dejitter demultiplexer and PCR extractor 420 is connected in signal communication with a first input of a phase adjuster 430. An output (for providing PCR2) of the dejitter demultiplexer and PCR extractor 425 is connected in signal communication with a second input of the phase adjuster 430. A first output of the phase adjuster 430 (for providing phase adjusted PCR1) is connected in signal communication with a first input of a counter 470 (for providing the start-up value of PCR1) and a first non-inverting input of a combiner 440. A second output of the phase adjuster 430 (for providing phase adjusted PCR2) is connected in signal communication with a first input of a counter 475 (for providing the start-up value of PCR2) and a first non-inverting input of a combiner 445.

An output of the combiner 440 is connected in signal communication with an input of a filter 450. An output of the filter 450 is connected in signal communication with an input of a Voltage Controlled Oscillator (VCO) 460. An output of the VCO 460 is connected in signal communication with a second input of the counter 470. An output of the counter 470 is connected in signal communication with a second inverting input of the combiner 440, an input of a decoder 480, and a third input of the phase adjuster 430.

An output of the combiner 445 is connected in signal communication with an input of a filter 455. An output of the filter 455 is connected in signal communication with an input of a VCO 465. An output of the VCO 465 is connected in signal communication with an input of a second input of the counter 475. An output of the counter 475 is connected in signal communication with a second inverting input of the combiner 445, an input of a decoder 485, and a fourth input of the phase adjuster 430.

A first input of the network 410 is available as a first input to the clock synchronization system 400, for receiving PCR in a first Transport Stream (TS1) relating to a channel change stream. A second input of the network 410 is available as a second input to the clock synchronization system 400, for receiving PCR in a second Transport Stream (TS2) relating to a regular stream. The PCR in the first and second Transport Streams are obtained from a system time clock input. An output of the decoder 480 is available as an output of the clock synchronization system 400. An output of the decoder 485 is also available as an output of the clock synchronization system 400

The dejitter demultiplexer and PCR extractor 420 and the dejitter demultiplexer and PCR extractor 425 remove the network jitter for TS1 and TS2, respectively. The dejitter demultiplexer and PCR extractor 420 and the dejitter demultiplexer and PCR extractor 425 also extract PCR packets from TS1 and TS2.

The filter 450, VCO 460, and counter 470 correspond to and/or are part of a phase lock loop for recovering STC (system time clock) from PCR packets of ST1. The filter 455, the VCO 465, and the counter 475 correspond to and/or are part of a phase lock loop for recovering STC (system time clock) from PCR packets of ST1.

The phase adjuster 430 is used to ensure that STC1 and STC2 are in the same phase.

The connection from the first output (relating to PCR1) of the phase adjuster 430 to the first input of the counter 470 is used to provide a startup value for STC1. The connection from the second output (relating to PCR2) of the phase adjuster 430 to the first input of the counter 475 is used to provide a startup value for STC2.

STC1 provides the system time clock for the decoder 480. STC2 provides the system time clock for the decoder 485.

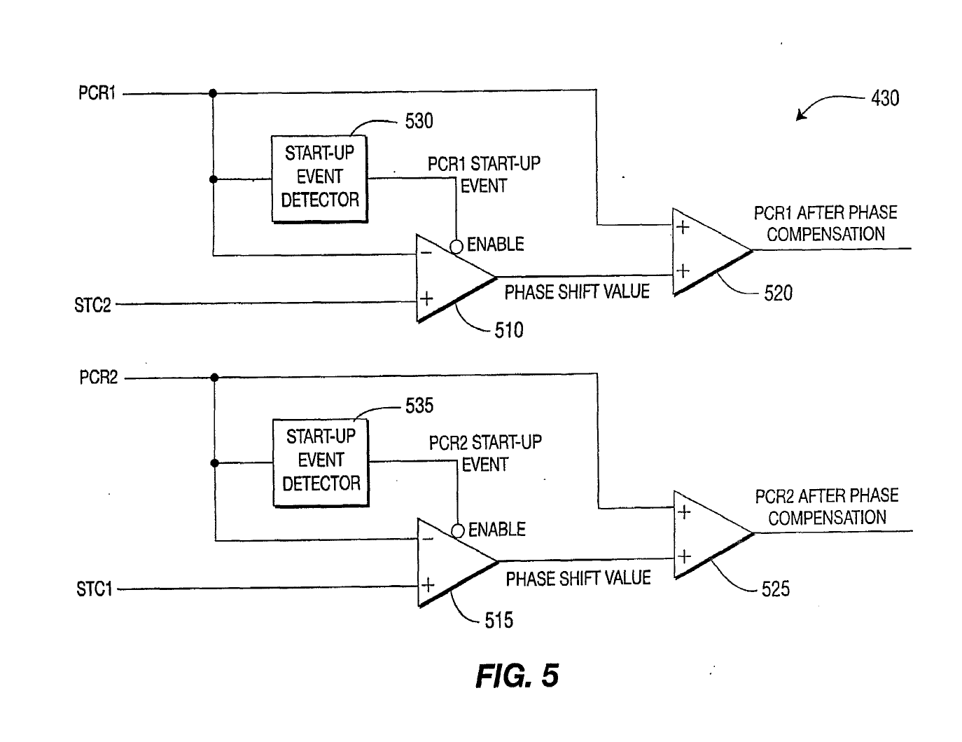

Turning to FIG. 5, the phase adjuster 430 of FIG. 4 is further illustrated. The phase adjuster 430 includes a comparator 510 having an output (for providing a phase shift value for PCR1) connected in signal communication with a first non-inverting input of a comparator 520.

The phase adjuster 430 further includes a comparator 515 having an output (for providing a phase shift value for PCR2) connected in signal communication with a first non-inverting input of a comparator 525.

An inverting input of the comparator 510, a second non-inverting input of the comparator 520, and an input of a PCR start-up event detector 530 are available as inputs of the phase adjuster 430, for receiving a PCR1 value. A non-inverting input of the comparator 510 is available as an input of the phase adjuster 430, for receiving a STC2 value. An output of the comparator 520 is available as an output of the phase adjuster 430, for outputting a PCR1 after phase compensation value.

The input of the PCR start-up event detector 530 receives a PCR1 value and detects a PCR1 start-up event. An output (for providing PCR1 start-up event) of the PCR start-up event detector 530 is connected in signal communication with an enable input of the comparator 510.

An inverting input of the comparator 515, a second non-inverting input of the comparator 525, and an input of a PCR start-up event detector 535 are available as inputs of the phase adjuster 430, for receiving a PCR2 value. A non-inverting input of the comparator 515 is available as an input of the phase adjuster 430, for receiving a STC1 value. An output of the comparator 525 is available as an output of the phase adjuster 430, for outputting a PCR2 after phase compensation value.

The input of the PCR start-up event detector 535 receives a PCR2 value and detects a PCR2 start-up event. An output (for providing PCR2 start-up event) of the PCR start-up event detector 535 is connected in signal communication with an enable input of the comparator 515.

Comparators 510 and 520 are for phase adjustment for PCR1. Comparators 515 and 525 are for phase adjustment for PCR2.

If PCR2 arrives before PCR1, then comparators 510 and 520 are enabled, and comparators 515 and 525 are disabled. In that case, PCR2 output will equal to PCR2 input, but PCR1 will be phase adjusted by comparators 510 and 520. Comparator 510 computes the phase shift value and comparator 520 does the actual phase shift for PCR1. The PCR1 start-up event triggers comparator 510 to subtract the start-up value of PCR1 from STC2 and latches the subtraction value to its output as the phase shift value for PCR1. Comparator 520 adds the phase shift value to PCR1 to generate its output, which is the phase adjusted PCR1.

If PCR2 does not arrive before PCR1, comparators 510 and 520 are disabled, and comparators 515 and 525 are enabled. In that case, PCR1 output will equal to PCR1 input, but PCR2 will be phase adjusted by comparators 515 and 525. Comparator 515 computes the phase shift value and comparator 525 does the actual phase shift for PCR2. The PCR2 start-up event triggers comparator 515 to subtract the start-up value of PCR2 from STC1 and latches the subtraction value to its output as the phase shift value for PCR2. Comparator 525 adds the phase shift value to PCR2 to generate its output, which is the phase adjusted PCR2.

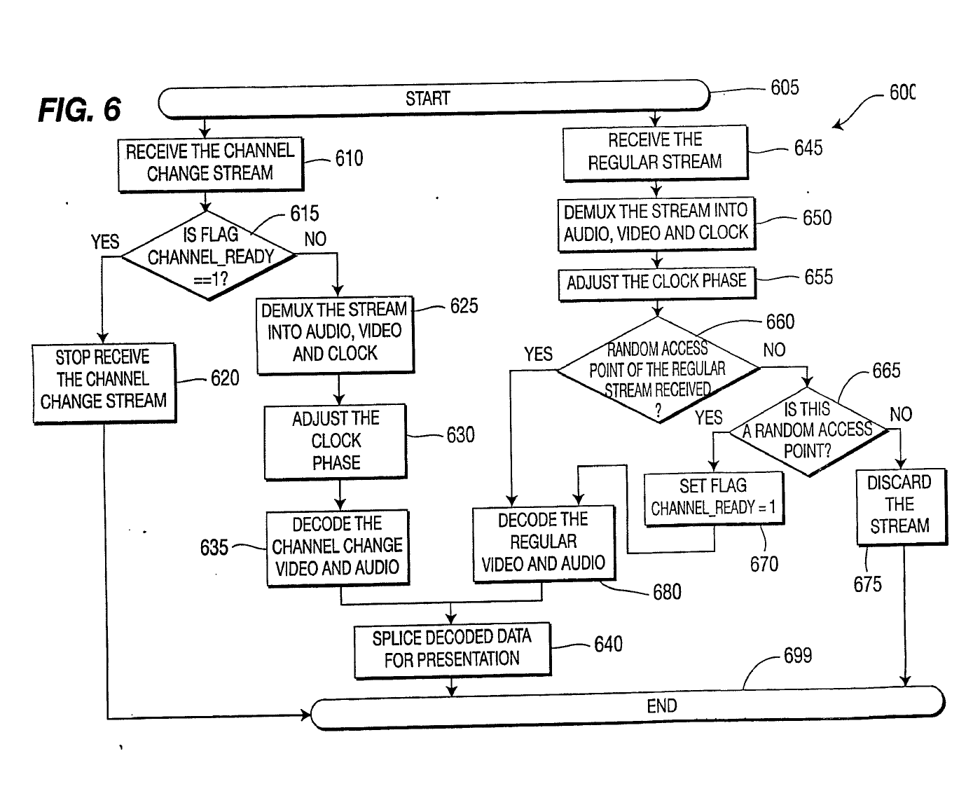

Turning to FIG. 6, an exemplary method for performing a fast channel change for digital video is indicated generally by the reference numeral 600.

The method 600 includes a start block 605 that passes control to a function block 610 and a function block 645.

The function block 610 receives the channel change stream, and passes control to a decision block 615. The decision block 615 determines whether or not the flag channel_ready is set to 1. If so, then control is passed to a function block 620. Otherwise, control is passed to a function block 625.

The function block 620 stops receiving the channel change stream, and passes control to an end block 699.

The function block 625 demultiplexes the stream into audio, video, and clock streams, and passes control to a function block 630. The function block 630 adjusts the clock phase, and passes control to a function block 635. The function block 635 decodes the channel change video and audio, and passes control to a function block 640.

The function block 640 splices the decoded data for presentation, and passes control to the end block 699.

The function block 645 receives the regular stream, and passes control to a function block 650. The function block 650 demultiplexes the stream into audio, video, and clock streams, and passes control to a function block 655. The function block 655 adjusts the clock phase, and passes control to a decision block 660. The decision block 660 determines whether or not a random access point of the regular stream has been received. If so, then control is passed to a function block 680. Otherwise, control is passed to a decision block 665.

The function block 680 decodes the regular video and audio, and passes control to the function block 640.

The decision block 665 determines whether or not the current access point is a random access point. If so, the control is passed to a function block 670. Otherwise, control is passed to a function block 675.

The function block 670 sets the flag channel_ready equal to one, and passes control to the function block 680.

The function block 675 discards the stream, and passes control to the end block 699. It is to be appreciated that while block 699 is shown and described with respect to FIG. 6 as an “end” block, such block may be implemented as a loop return for repeating the preceding blocks.

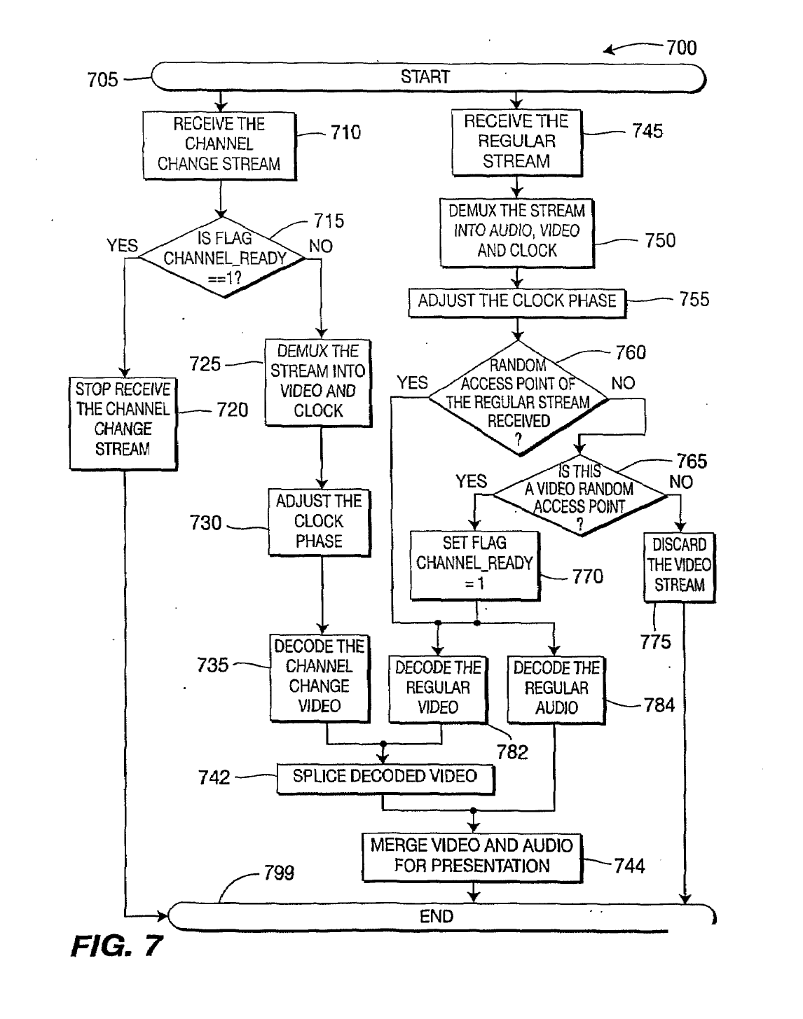

Turning to FIG. 7, another exemplary method for performing a fast channel change for digital video is indicated generally by the reference numeral 700.

The method 700 includes a start bloc 705 that passes control to a function block 710 and a function block 745.

The function block 710 receives the channel change stream, and passes control to a decision block 715. The decision block 715 determines whether or not the flag channel_ready is set to 1. If so, then control is passed to a function block 720. Otherwise, control is passed to a function block 725.

The function block 720 stops receiving the channel change stream, and passes control to an end block 799.

The function block 725 demultiplexes the stream into audio, video, and clock streams, and passes control to a function block 730. The function block 730 adjusts the clock phase, and passes control to a function block 735. The function block 735 decodes the channel change video, and passes control to a function block 742.

The function block 742 splices the decoded video, and passes control to a function block 744.

The function block 745 receives the regular stream, and passes control to a function block 750. The function block 750 demultiplexes the stream into audio, video, and clock streams, and passes control to a function block 755. The function block 755 adjusts the clock phase, and passes control to a decision block 760. The decision block 760 determines whether or not a random access point of the regular stream has been received. If so, then control is passed to a function block 782 and a function block 784. Otherwise, control is passed to a decision block 765.

The function block 782 decodes the regular video, and passes control to the function block 742.

The function block 784 decodes the regular audio, and passes control to the function block 744. The function block 744 merges the video and audio for presentation, and passes control to the end block 799.

The decision block 765 determines whether or not the current access point is a random access point. If so, the control is passed to a function block 770. Otherwise, control is passed to a function block 775.

The function block 770 sets the flag channel_ready equal to one, and passes control to the function block 782 and the function block 784.

The function block 775 discards the video stream, and passes control to the end block 799. It is to be appreciated that while block 799 is shown and described with respect to FIG. 7 as an “end” block, such block may be implemented as a loop return for repeating the preceding blocks.

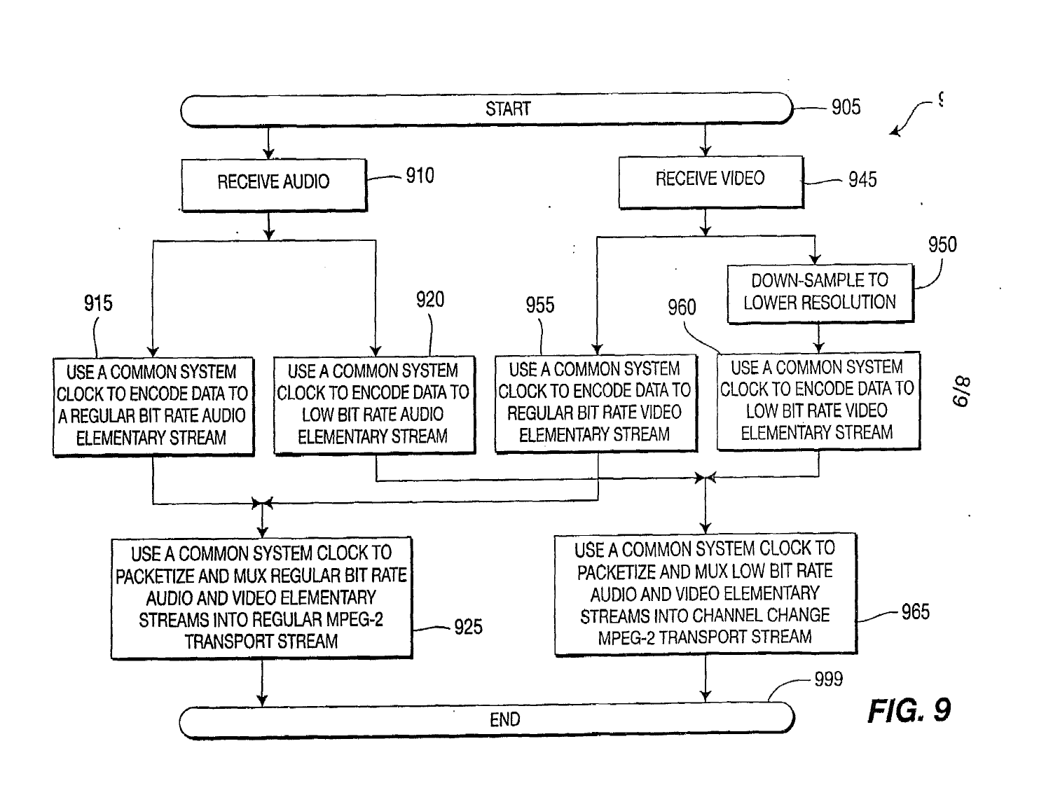

Turning to FIG. 9, an exemplary method for encoding digital media to allow a subsequent fast channel change is indicated generally by the reference numeral 900.

The method 900 includes a start block 905 that passes control to a function block 910 and a function block 945.

The function block 910 receives audio, and passes control to a function block 915 and a function block 920.

The function block 915 encodes the received audio to a regular bit-rate audio elementary stream using a common system clock, and passes control to a function block 925.

The function block 920 encodes to a low bit-rate audio elementary stream using a common system clock, and passes control to a function block 965.

The function block 925 packetizes and multiplexes the regular bit-rate audio and video elementary streams into a regular MPEG-2 transport stream using a common system clock, and passes control to an end block 999.

The function block 945 receives video, and passes control to a function block 955 and a function block 950.

The function block 955 encodes the received video to a regular bit-rate video elementary stream using a common system clock, and passes control to the function block 925.

The function block 950 down-samples the received video to a lower resolution, and passes control to a function block 960. The function block 960 encodes the down-sampled video to a low bit-rate video elementary stream using a common system clock, and passes control to the function block 965.

The function block 965 packetizes and multiplexes the low bit-rate audio and video elementary streams into a channel change MPEG-2 transport stream using a common system clock, and passes control to the end block 999. It is to be appreciated that while block 999 is shown and described with respect to FIG. 9 as an “end” block, such block may be implemented as a loop return for repeating the preceding blocks.

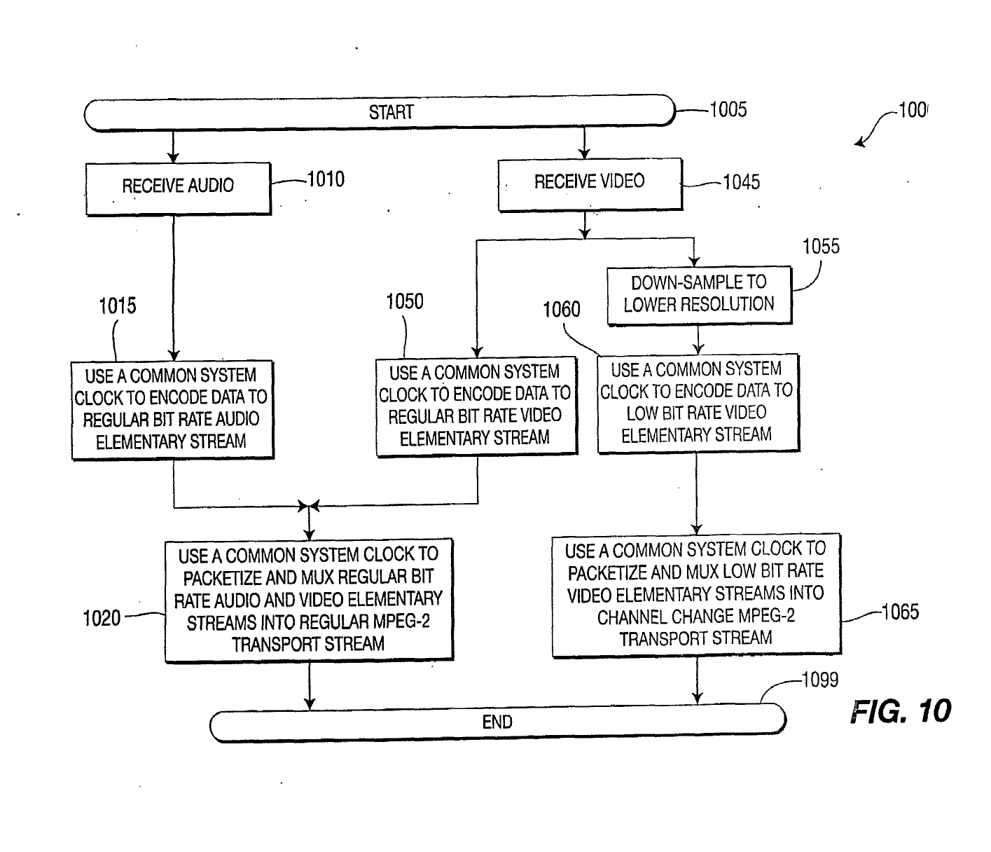

Turning to FIG. 10, another exemplary method for encoding digital media to allow a subsequent fast channel change is indicated generally by the reference numeral 1000.

The method 1000 includes a start block 1005 that passes control to a function block 1010 and a function block 1045.

The function block 1010 receives audio, and passes control to a function block 1015. The function block 1015 encodes the received audio to a regular bit-rate audio elementary stream using a common system clock, and passes control to a function block 1020.

The function block 1020 packetizes and multiplexes the regular bit-rate audio and video elementary streams into a regular MPEG-2 transport stream using a common system clock, and passes control to an end block 1099.

The function block 1045 receives video, and passes control to a function block 1050 and a function block 1055.

The function block 1050 encodes the received video to a regular bit-rate video elementary stream using a common system clock, and passes control to the function block 1020.

The function block 1055 down-samples the received video to a lower resolution, and passes control to a function block 1060.

The function block 1060 encodes the down-sampled video to a low bit-rate video elementary stream using a common system clock, and passes control to a function block 1065.

The function block 1065 packetizes and multiplexes the low bit-rate elementary streams into a channel change MPEG-2 transport stream using a common system clock, and passes control to the end block 1099. It is to be appreciated that while block 1099 is shown and described with respect to FIG. 10 as an “end” block, such block may be implemented as a loop return for repeating the preceding blocks.

A description will now be given of some of the many attendant advantages/features of the present invention, some of which have been mentioned above. For example, one advantage/feature is an apparatus that includes at least one encoder for receiving normal video data and channel change video data and encoding the normal video data and the channel change video data in a normal video stream and a channel change video stream, respectively, using a common system clock to provide synchronization between the normal video stream and the channel change video stream. The normal video stream and the channel change video stream are encoded for transport separately at a transport level.

Another advantage/feature is the apparatus having the at least one encoder as described above, wherein the at least one encoder includes a first video encoder for encoding the normal video data into the normal video stream, and a second video encoder for encoding the channel change video data into the channel change video stream.

Yet another advantage/feature is the apparatus having the at least one encoder as described above, wherein the normal video stream is multiplexed for transport with a normal audio stream while the channel change video stream is without multiplexing for transport of any audio stream.

Moreover, another advantage/feature is the apparatus having the at least one encoder as described above, wherein the normal video stream is multiplexed for transport with a normal audio stream while the channel change video stream is multiplexed for transport with a channel change audio stream.

Further, another advantage/feature is the apparatus having the at least one encoder wherein the normal video stream is multiplexed for transport with a normal audio stream while the channel change video stream is multiplexed for transport with a channel change audio stream as described above, wherein the channel change audio stream has a lower bitrate than the normal audio stream.

Also, another advantage/feature is the apparatus having the at least one encoder as described above, wherein the common system clock is a program clock reference.

Additionally, another advantage/feature is the apparatus having the at least one encoder as described above, wherein channel change stream coded pictures in the channel change video stream are of lower resolution than normal stream coded pictures in the normal video stream.

Moreover, another advantage/feature is the apparatus having the at least one encoder as described above, wherein channel change stream coded pictures in the channel change video stream are of lower frame rate than normal stream coded pictures in the normal video stream.

Further, another advantage/feature is the apparatus having the at least one encoder as described above, wherein channel change stream coded pictures in the channel change video stream are coded at a lower bitrate than normal stream pictures in the normal video stream.

Also, another advantage/feature is the apparatus having the at least one encoder as described above, wherein the apparatus is comprised in a digital video broadcast system.

Additionally, another advantage/feature is the apparatus having the at least one encoder as described above, wherein the apparatus is comprised in a Digital Subscriber Line system, a cable television system, or a satellite television system.

Moreover, another advantage/feature is an apparatus that includes at least one decoder and a phase adjuster. The at least one decoder is for receiving normal video data and channel change video data separately at a transport layer and decoding the normal video data and the channel change video data from a normal video stream and a channel change video stream, respectively. The phase adjuster is for phase adjusting at least one of the normal video stream and the channel change video stream to provide synchronization between the normal video stream and the channel change video stream.

Another advantage/feature is the apparatus having the at least one decoder and the phase adjuster as described above, wherein the at least one decoder includes a first video decoder for decoding the normal video data from the normal video stream, and a second video decoder for decoding the channel change video data from the channel change video stream.

Yet another advantage/feature is the apparatus having the at least one decoder and the phase adjuster as described above, wherein the normal video stream is received at the transport layer multiplexed with a normal audio stream while the channel change video stream is received at the transport layer without multiplexing of any audio stream.

Moreover, another advantage/feature is the apparatus having the at least one decoder and the phase adjuster as described above, wherein the normal video stream is received at the transport layer multiplexed with a normal audio stream while the channel change video stream is received at the transport layer multiplexed with a channel change audio stream.

Further, another advantage/feature is the apparatus having the at least one decoder and the phase adjuster wherein the normal video stream is received at the transport layer multiplexed with a normal audio stream while the channel change video stream is received at the transport layer multiplexed with a channel change audio stream as described above, wherein the channel change audio stream has a lower bitrate than the normal audio stream.

Also, another advantage/feature is the apparatus having the at least one decoder and the phase adjuster as described above, wherein the common system clock is a program clock reference.

Additionally, another advantage/feature is the apparatus having the at least one decoder and the phase adjuster as described above, wherein channel change stream coded pictures in the channel change video stream are of lower resolution than normal stream coded pictures in the normal video stream.

Moreover, another advantage/feature is the apparatus having the at least one decoder and the phase adjuster as described above, wherein channel change stream coded pictures in the channel change video stream are of lower frame rate than normal stream coded pictures in the normal video stream.

Further, another advantage/feature is the apparatus having the at least one decoder and the phase adjuster as described above, wherein channel change stream coded pictures in the channel change video stream are coded at a lower bitrate than normal stream pictures in the normal video stream.

Also, another advantage/feature is the apparatus having the at least one decoder and the phase adjuster as described above, wherein the apparatus is comprised in a digital video broadcast system.

Additionally, another advantage/feature is the apparatus having the at least one decoder and the phase adjuster as described above, wherein the apparatus is comprised in a Digital Subscriber Line system, a cable television system, or a satellite television system.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
at least one encoder for receiving normal video data and channel change video data and encoding the normal video data and the channel change video data in a normal video stream and a channel change video stream, respectively, using a common system clock to provide synchronization between the normal video stream and the channel change video stream,
wherein the normal video stream and the channel change video stream are encoded for transport separately at a transport level.

2. The apparatus of claim 1, wherein the at least one encoder comprises:
a first video encoder for encoding the normal video data into the normal video stream; and
a second video encoder for encoding the channel change video data into the channel change video stream.

3. The apparatus of claim 1, wherein the normal video stream is multiplexed for transport with a normal audio stream while the channel change video stream is without multiplexing for transport of any audio stream.

4. The apparatus of claim 1, wherein the normal video stream is multiplexed for transport with a normal audio stream while the channel change video stream is multiplexed for transport with a channel change audio stream.

5. The apparatus of claim 4, wherein the channel change audio stream has a lower bitrate than the normal audio stream.

6. The apparatus of claim 1, wherein the common system clock is a program clock reference.

7. The apparatus of claim 1, wherein channel change stream coded pictures in the channel change video stream are of lower resolution than normal stream coded pictures in the normal video stream.

8. The apparatus of claim 1, wherein channel change stream coded pictures in the channel change video stream are of lower frame rate than normal stream coded pictures in the normal video stream.

9. The apparatus of claim 1, wherein channel change stream coded pictures in the channel change video stream are coded at a lower bitrate than normal stream pictures in the normal video stream.

10. The apparatus of claim 1, wherein the apparatus is comprised in a digital video broadcast system.

11. The apparatus of claim 1, wherein the apparatus is comprised in a Digital Subscriber Line system, a cable television system, or a satellite television system.

12. A method, comprising:
receiving normal video data and channel change video data; and
encoding the normal video data and the channel change video data in a normal video stream and a channel change video stream, respectively, using a common system clock to provide synchronization between the normal video stream and the channel change video stream,
wherein the normal video stream and the channel change video stream are encoded for transport separately at a transport level.

13. The method of claim 12, wherein the normal video stream is multiplexed for transport with a normal audio stream while the channel change video stream is without multiplexing for transport of any audio stream.

14. The method of claim 12, wherein the normal video stream is multiplexed for transport with a normal audio stream while the channel change video stream is multiplexed for transport with a channel change audio stream.

15. The method of claim 14, wherein the channel change audio stream has a lower bitrate than the normal audio stream.

16. The method of claim 12, wherein the common system clock is a program clock reference.

17. The method of claim 12, wherein channel change stream coded pictures in the channel change video stream are of lower resolution than normal stream coded pictures in the normal video stream.

18. The method of claim 12, wherein channel change stream coded pictures in the channel change video stream are of lower frame rate than normal stream coded pictures in the normal video stream.

19. The method of claim 12, wherein channel change stream coded pictures in the channel change video stream are coded at a lower bitrate than normal stream pictures in the normal video stream.

20. The method of claim 12, wherein the method is performed in a digital video broadcast system.

21. The method of claim 12, wherein the method is performed in a Digital Subscriber Line system, a cable television system, or a satellite television system.

22. An apparatus, comprising:
at least one decoder for receiving normal video data and channel change video data separately at a transport layer and decoding the normal video data and the channel change video data from a normal video stream and a channel change video stream, respectively; and
means for phase adjusting at least one of the normal video stream and the channel change video stream to provide synchronization between the normal video stream and the channel change video stream.

23. The apparatus of claim 22, wherein the at least one decoder comprises:
a first video decoder for decoding the normal video data from the normal video stream; and
a second video decoder for decoding the channel change video data from the channel change video stream.

24. The apparatus of claim 22, wherein the normal video stream is received at the transport layer multiplexed with a normal audio stream while the channel change video stream is received at the transport layer without multiplexing of any audio stream.

25. The apparatus of claim 22, wherein the normal video stream is received at the transport layer multiplexed with a normal audio stream while the channel change video stream is received at the transport layer multiplexed with a channel change audio stream.

26. The apparatus of claim 25, wherein the channel change audio stream has a lower bitrate than the normal audio stream.

27. The apparatus of claim 22, wherein the common system clock is a program clock reference.

28. The apparatus of claim 22, wherein channel change stream coded pictures in the channel change video stream are of lower resolution than normal stream coded pictures in the normal video stream.

29. The apparatus of claim 22, wherein channel change stream coded pictures in the channel change video stream are of lower frame rate than normal stream coded pictures in the normal video stream.

30. The apparatus of claim 22, wherein channel change stream coded pictures in the channel change video stream are coded at a lower bitrate than normal stream pictures in the normal video stream.

31. The apparatus of claim 22, wherein the apparatus is comprised in a digital video broadcast system.

32. The apparatus of claim 22, wherein the apparatus is comprised in a Digital Subscriber Line system, a cable television system, or a satellite television system.

33. A method, comprising:
receiving normal video data and channel change video data separately at a transport layer and decoding the normal video data and the channel change video data from a normal video stream and a channel change video stream, respectively; and
phase adjusting at least one of the normal video stream and the channel change video stream to provide synchronization between the normal video stream and the channel change video stream.

34. The method of claim 33, wherein the normal video stream is received at the transport layer multiplexed with a normal audio stream while the channel change video stream is received at the transport layer without multiplexing of any audio stream.

35. The method of claim 33, wherein the normal video stream is received at the transport layer multiplexed with a normal audio stream while the channel change video stream is received at the transport layer multiplexed with a channel change audio stream.

36. The method of claim 35, wherein the channel change audio stream has a lower bitrate than the normal audio stream.

37. The method of claim 33, wherein the common system clock is a program clock reference.

38. The method of claim 33, wherein channel change stream coded pictures in the channel change video stream are of lower resolution than normal stream coded pictures in the normal video stream.

39. The method of claim 33, wherein channel change stream coded pictures in the channel change video stream are of lower frame rate than normal stream coded pictures in the normal video stream.

40. The method of claim 33, wherein channel change stream coded pictures in the channel change video stream are coded at a lower bitrate than normal stream pictures in the normal video stream.

41. The method of claim 33, wherein the method is performed in a digital video broadcast system.

42. The method of claim 33, wherein the method is performed in a Digital Subscriber Line system, a cable television system, or a satellite television system.

43. A video signal structure for video encoding, comprising:
normal video data and channel change video data encoded in a normal video stream and a channel change video stream, respectively, using a common system clock to provide synchronization between the normal video stream and the channel change video stream,
wherein the normal video stream and the channel change video stream are encoded for transport separately at a transport level.

44. A storage media having video signal data encoded thereupon, comprising:
normal video data and channel change video data encoded in a normal video stream and a channel change video stream, respectively, using a common system clock to provide synchronization between the normal video stream and the channel change video stream,
wherein the normal video stream and the channel change video stream are encoded for transport separately at a transport level.
